(19) United States
(12) Patent Application Publication
(10) Pub. No.: US 2019/0320141 A1
(43) Pub. Date: Oct. 17, 2019

(54) Method for initiating and organizing video calls in which video effects apply to video streams captured by cameras on users' devices

(71) Applicant: Hadif Hamad Mehad Mohamed Almheiri, Sharjah (UA)

(72) Inventor: Hadif Hamad Mehad Mohamed Almheiri, Sharjah (UA)

(21) Appl. No.: 15/954,635

(22) Filed: Apr. 17, 2018

(51) Int. Cl. H04N 7/15; H04N 7/14; G06T 13/40

(52) U.S. Cl. CPC H04N 7/157; G06T 13/40; H04N 7/141

(57) ABSTRACT

In one embodiment, the present invention is a mobile application that, after being installed and activated on a computing device, allows a first user to initiate a video call with a second user. Before and during the video call, the first and the second user may choose to apply video effects to the video streams captured by the cameras on their computing devices. At least one of those video effects, may transform the video streams into cartoon video.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to the field of video conferencing applications. Many patented inventions relate to this field. For example, U.S. Pat. No. 9,942,517 by Cassini, et al. provides for a video-enabled communication system that comprises a control unit, coupled with a camera, the camera acquiring an image of a local participant to provide to a remote participant during a video communication session. U.S. Pat. No. 9,935,987 by Bader-Natal, et al. provides for a participation queue system and method for online video conferencing. U.S. Pat. No. 9,883,139 by Feng, et al. provides for a method for communication including the establishment of multiple communication links over a packet network between a server and plurality of client computers that are to participate in a video teleconference. U.S. Pat. No. 9,832,369 by Oyman, et al. discloses a technology for a local user equipment operable to perform video conferencing with a remote user equipment. U.S. Pat. No. 9,800,833 by Lu, et al describes a system that may include capturing images that are associated with a video conference communication session, obtaining a video conference policy associated with the video conference communication session, applying object pattern recognition to the images to detect an object in the images, and retrieve first replacement image content according to the video conference policy. U.S. Pat. No. 9,794,515 by Oyman discloses a technology for a multimedia telephony services over internet protocol (IP) multimedia subsystems (IMS) (MTSI) receiver operable to support region of interest (ROI) signaling with a MTSI sender.

None of these inventions allow their users to initiate and organize video calls in which video effects apply to the video streams captured by cameras on users' computing devices. In this regard, it is worth mentioning that U.S. Pat. No. 8,581,930 by Sio describes a method for automatically producing video cartoon with superimposed faces from cartoon template. However, the method does not apply specifically to video calls.

There is a pressing social need for an invention that initiates and organizes video calls in which video effects apply to the video streams captured by cameras on users' devices. Such an invention will make video conferencing more entertaining and engaging for adults and children. It will also allow users of the invention to participate in video conferencing while, at the same time, keeping their privacy. The present invention fills the aforementioned gaps in the prior art.

Relevant prior art includes:

U.S. Pat. No. 9,942,517 by Cassini, et al.

U.S. Pat. No. 9,935,987 by Bader-Natal, et al.

U.S. Pat. No. 9,883,139 by Feng, et al.

U.S. Pat. No. 9,832,369 by Oyman, et al.

U.S. Pat. No. 9,800,833 by Lu, et al

U.S. Pat. No. 9,794,515 by Oyman

U.S. Pat. No. 8,581,930 by Sio

### SUMMARY OF THE INVENTION

The present invention is a software application that, after being installed and activated on a computing device, allows a first user to click on a button called “Cartoon Call”. When the first user clicks on a button called “Cartoon Call”, a camera on the first user's device turns on. When the camera on the first user's device turns on, the invention detects the face of the first user captured by the camera on the first user's device. When the invention detects the face of the first user captured by the camera on the first user's device, the first user of the invention selects a video effect which will apply to the video stream captured by the camera on the first user's device. When the first user of the invention selects a video effect which will apply to the video stream captured by the camera on the first user's device, the invention initiates a video call with a second user of the invention. When the invention initiates a video call with a second user of the invention, the second user of the invention accepts the incoming video call. When the second user of the invention accepts the incoming video call, a camera on the second user's device turns on. When a camera on the second user's device turns on, the invention detects the face of the second user captured by the camera on the second user's device. When the invention detects the face of the second user captured by the camera on the second user's device, the second user of the invention selects a video effect which will apply to the video stream captured by the camera on the second user's device. When the second user of the invention selects a video effect which will apply to the video stream captured by the camera on the second user's device, the call between the first and the second user of the invention is initiated and video effects apply to the video stream captured by the cameras on the first and the second users' devices.

### BRIEF DESCRIPTION OF THE DRAWINGS

FIG. 1 is a flowchart of an exemplary process of operation of the invention

FIG. 2 is an exemplary user interface allowing the user of the invention to initiate a video call in which video effects apply to video streams captured by cameras on users' devices

FIG. 3 is an exemplary user interface allowing the user of the invention to observe video effects applying to video streams captured by cameras on users' devices

### DRAWINGS—REFERENCE NUMERALS

10—start of the exemplary process of operation of the invention

20—a first user clicks on a button called “Cartoon Call”

30—a camera on the first user's device turns on

40—the invention detects the face of the first user captured by the camera on the first user's device

50—the first user of the invention selects a video effect which will apply to the video stream captured by the camera on the first user's device

60—the invention initiates a video call with a second user of the invention

70—the second user of the invention accepts the incoming video call

80—a camera on the second user's device turns on

90—the invention detects the face of the second user captured by the camera on the second user's device

100—the second user of the invention selects a video effect which will apply to the video stream captured by the camera on the second user's device

110—the call between the first and the second user of the invention is initiated and video effects apply to the video stream captured by the cameras on the first and the second users' devices

120—end of the exemplary process of operation of the invention

130—an exemplary user interface allowing the user of the invention to initiate a video call in which video effects apply to video streams captured by cameras on users' devices

140—an exemplary section showing the current time, the battery status, and the status of the Wi-Fi connection

150—an exemplary section showing text messages exchanged between users of the invention

160—a button “Cartoon Call”

170—a button “Cartoon Message”

180—a button in the form of a star

190—exemplary text “Type your message”

200—an empty field

210—an exemplary user interface allowing the user of the invention to observe video effects applying to video streams captured by cameras on users' devices

220—an exemplary section showing a video stream captured by a first user of the invention

230—an exemplary section showing a video stream captured by a second user of the invention

240—a button allowing the user of the invention to change the video effect applying to the video stream captured by the camera on the user's device

250—a button indicating that the current video call is in progress

260—a button allowing the user of the invention to mute the sound of the video call

### DETAILED DESCRIPTION OF THE INVENTION

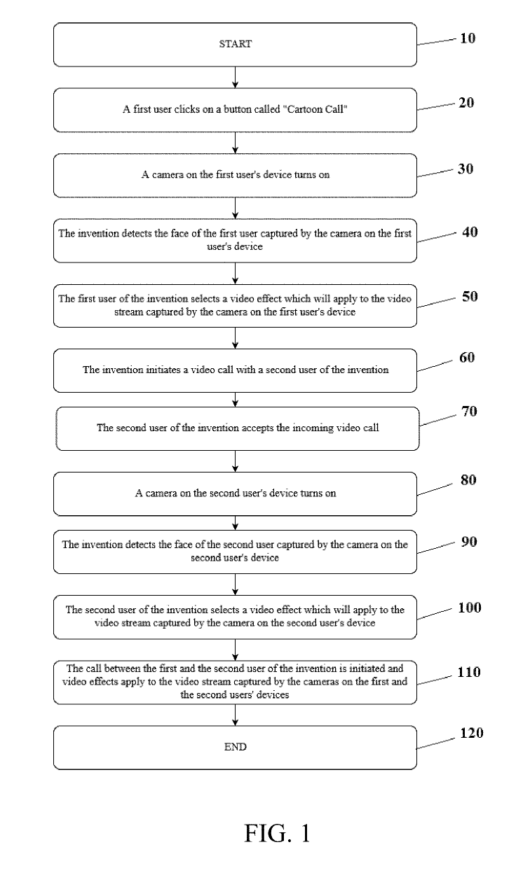

Referring now to the invention in more detail, in FIG. 1 there is shown a flowchart of an exemplary process of operation of the invention consisting of the following steps: start of the exemplary process of operation of the invention 10, a first user clicks on a button called “Cartoon Call” 20, a camera on the first user's device turns on 30, the invention detects the face of the first user captured by the camera on the first user's device 40, the first user of the invention selects a video effect which will apply to the video stream captured by the camera on the first user's device 50, the invention initiates a video call with a second user of the invention 60, the second user of the invention accepts the incoming video call 70, a camera on the second user's device turns on 80, the invention detects the face of the second user captured by the camera on the second user's device 90, the second user of the invention selects a video effect which will apply to the video stream captured by the camera on the second user's device 100, the call between the first and the second user of the invention is initiated and video effects apply to the video stream captured by the cameras on the first and the second user's devices 110, end of the exemplary process of operation of the invention 120.

In more detail, still referring to the invention of FIG. 1, the exemplary process of operation of the invention starts at step 10. At step 20, the first user of the invention clicks on a button called “Cartoon Call”. In other embodiments, the button called “Cartoon Call” may be called, for example, “Special Effects Call” and “Special Video Effects Call”. Afterwards, a camera on the first user's device turns on 30. Next, the invention detects the face of the first user captured by the camera on the first user's device 40. Subsequently, the first user of the invention selects a video effect which will apply to the video stream captured by the camera on the first user's device 50. More specifically, the first user can choose amongst various video effects, including, but not limited to, video effects which automatically transform the video stream captured by the camera on the first user's device into cartoon video. At step 60, the invention initiates a video call with a second user of the invention. At step 70, the second user of the invention accepts the incoming video call. At step 80, a camera on the second user's device turns on. At step 90, the invention detects the face of the second user captured by the camera on the second user's device. At step 100, the second user of the invention selects a video effect which will apply to the video stream captured by the camera on the second user's device. More specifically, the second user can choose amongst various video effects, including, but not limited to, video effects which automatically transform the video stream captured by the camera on the second user into cartoon video. Afterwards, the call between the first and the second user of the invention is initiated and video effects apply to the video stream captured by the cameras on the first and second users' devices 110. The exemplary process of operation of the invention ends at step 120.

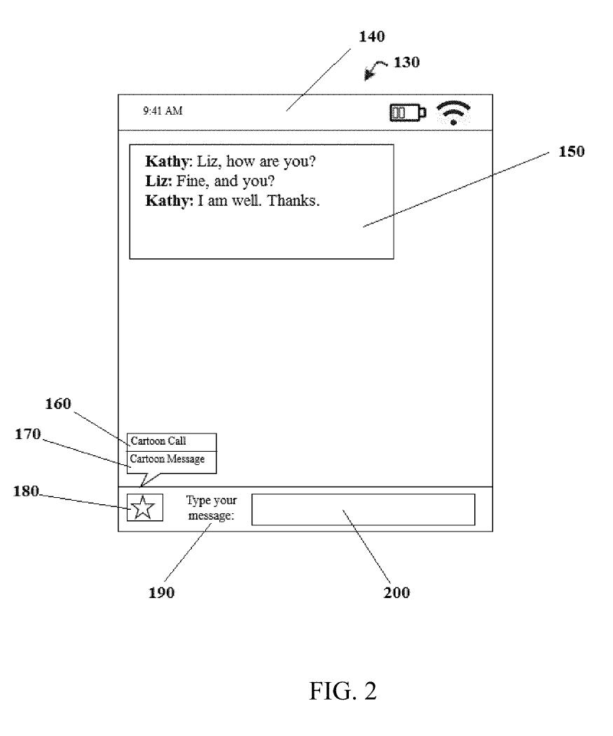

Referring now to the invention in more detail, in FIG. 2 there is shown an exemplary user interface allowing the user of the invention to initiate a video call in which video effects apply to video streams captured by cameras on users' devices 130. The exemplary user interface allowing the user of the invention to initiate a video call in which video effects apply to video streams captured by cameras on users' devices 130 includes an exemplary section showing the current time, the battery status, and the status of the Wi-Fi connection 140, an exemplary section showing text messages exchanged between users of the invention 150, a button “Cartoon Call” 160, a button “Cartoon Message” 170, a button in the form of a star 180, exemplary text “Type your message” 190, and an empty field 200.

In more detail, still referring to the invention of FIG. 2, the exemplary user interface allowing the user of the invention to initiate a video call in which video effects apply to video streams captured by cameras on users' devices 130 may be implemented in mobile software applications and other software applications. The exemplary section showing the current time, the battery status, and the status of the Wi-Fi connection 140 indicates the current time in the location of the user of the invention, the battery status of the mobile device of the user of the invention, and the speed of the Wi-Fi connection of the user of the invention. The exemplary section showing text messages exchanged between users of the invention 150 contains the following exemplary text: “Kathy: Liz, how are you? Liz: Fine, and you? Kathy: I am well. Thanks”. If a user of the invention clicks on the button Cartoon Call 160, he will initiate step 30 specified in FIG. 1. If a user of the invention clicks on the button “Cartoon Message” 170, he will be able to send a video recording of himself to another user of the invention. A video effect chosen by the user who sends the recording will apply to the recording. For example, the video effect may transform the recording captured by the camera on a user's device into cartoon video. When a user of the invention clicks on the button in the form of a star 180, the button “Cartoon Call” 160 and the button “Cartoon Message” 170 will appear as shown on FIG. 2. The exemplary text “Type your message” 190 instructs the user of the invention that he can add a message in the empty field 200.

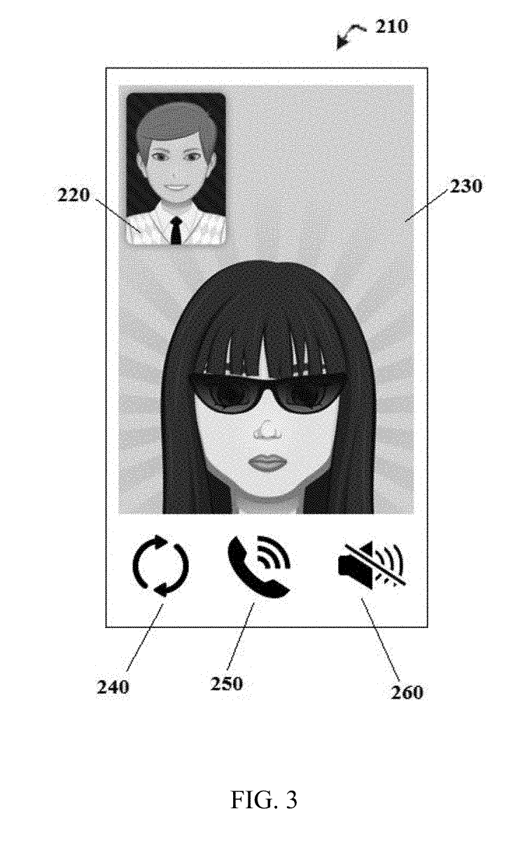

Referring now to the invention in more detail, in FIG. 3 there is shown an exemplary user interface allowing the user of the invention to observe video effects applying to video streams captured by cameras on users' devices 210. The exemplary user interface allowing the user of the invention to observe video effects applying to video streams captured by cameras on users' devices 210 includes an exemplary section showing a video stream captured by a first user of the invention 220, an exemplary section showing a video stream captured by a second user of the invention 230, a button allowing the user of the invention to change the video effect applying to the video stream captured by the camera on the user's device 240, a button indicating that the current video call is in progress 250, a button allowing the user of the invention to mute the sound of the video call 260.

In more detail, still referring to the invention of FIG. 3, the exemplary user interface allowing the user of the invention to observe video effects applying to video streams captured by cameras on users' devices 210 may be implemented in mobile software applications or other software applications. A video effect chosen by the first user applies to the video in the exemplary section showing a video stream captured by a first user of the invention 220. For example, the video effect may transform the recording captured by the camera on first user's device into cartoon video. A video effect chosen by the second user applies to the video in the exemplary section showing a video stream captured by a second user of the invention 230. For example, the video effect may transform the video stream captured by the camera on the second user's device into cartoon video. After the user of the invention clicks on the button allowing the user of the invention to change the video effect applying to the video stream captured by the camera on the user's device 240, the user can select a variety of video effects, including, but not limited to, a video effect which transforms the video stream captured by the camera on the user's device into cartoon video. The button indicating that the current video call is in progress 250 appears on the exemplary user interface allowing the user of the invention to observe video effects applying to video streams captured by cameras on users' devices 210 only if a video call between two users of the invention is in progress. If a user of the invention would like to mute a video call, he needs to click on the button allowing the user of the invention to mute the sound of the video call 260.

The advantages of the present invention include, without limitation:
The invention makes video conferencing more entertaining and engaging.
The invention allows users of the invention to participate in video conferencing while, at the same time, keeping their privacy.
The invention makes video conferencing attractive for children.

In one embodiment of the invention, the present invention is a software application that, after being installed and activated on a mobile device, allows a first user of the invention to click on a button called “Cartoon Call”. Afterwards, a camera on the first user's device turns on. Next, the invention detects the face of the first user captured by the camera on the first user's device. Subsequently, the first user of the invention selects a video effect which will apply to the video stream captured by the camera on the first user's device. Then, the invention initiates a video call with a second user of the invention. Afterwards, the second user of the invention accepts the incoming video call. Thereafter, a camera on the second user's device turns on. Consequently, the invention detects the face of the second user captured by the camera on the second user's device. Next, the second user of the invention select a video effect which will apply to the video stream captured by the camera on the second user's device. Thereafter, the call between the first and the second user of the invention is initiated and video effects apply to the video stream captured by the cameras on the first and the second users' devices.

The embodiment is able to be implemented, for example, using a machine-readable medium or article which is able to store an instruction or a set of instructions that, if executed by a machine, cause the machine to perform the operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software.

The machine-readable medium or article is able to include, for example, any suitable type of memory unit, memory device, memory article, memory medium, storage device, storage article, storage medium and/or storage unit; for example, memory, removable or non-removable media, erasable or non-erasable media, write-able or re-write-able media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like.

The instructions are able to include any suitable type of code, for example, source code, compiled code, interpreted code, executable code, static code, dynamic code, or the like, and are able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A method for initiating and organizing video calls in which video effects apply to video streams captured by cameras on users' computing devices, the method comprising the following steps:
in a computing device, a first user clicks on a button called “Cartoon Call”;
when the first user clicks on a button called “Cartoon Call”, a camera on the first user's computing device turns on;
when a camera on the first user's computing device turns on, the invention detects the face of the first user captured by the camera on the first user's computing device;
when the invention detects the face of the first user captured by the camera on the first user's computing device, the first user of the invention selects a video effect which will apply to the video stream captured by the camera on the first user's computing device;
when the first user of the invention selects a video effect which will apply to the video stream captured by the camera on the first user's computing device, the invention initiates a video call with a second user of the invention;
when the invention initiates a video call with a second user of the invention, the second user of the invention accepts the incoming video call;
when the second user of the invention accepts the incoming video call, a camera on the second user's computing device turns on;
when a camera on the second user's computing device turns on, the invention detects the face of the second user captured by the camera on the second user's computing device;
when the invention detects the face of the second user captured by the camera on the second user's computing device, the second user of the invention selects a video effect which will apply to the video stream captured by the camera on the second user's computing device;
when the second user of the invention selects a video effect which will apply to the video stream captured by the camera on the second user's computing device, the call between the first and the second user of the invention is initiated and video effects apply to the video stream captured by the cameras on the first and the second users' computing devices.

2. The method of claim 1, wherein the video effect selected by the first user of the invention may transform the video stream captured by the camera on the first user's computing device into cartoon video.

3. The method of claim 1, wherein the video effect selected by the second user of the invention may transform the video stream captured by the camera on the second user's computing device into cartoon video.

4. The method of claim 1, wherein the video effect selected by the first user of the invention does not alter the video stream captured by the camera on the first user's computing device.

5. The method of claim 1, wherein the video effect selected by the second user of the invention does not alter the video stream captured by the camera on the second user's computing device.

6. The method as in any of the preceding claims, in which the order of the steps differs from the order of the steps described in claim 1.
